(19) United States
(12) Patent Application Publication
(10) Pub. No.: US 2025/0077336 A1
(43) Pub. Date: Mar. 6, 2025

(54) SYSTEMS, APPARATUSES, METHODS, AND COMPUTER PROGRAM PRODUCTS FOR OPTIMIZING ONE OR MORE ASSETS

(71) Applicant: HONEYWELL INTERNATIONAL INC., Charlotte, NC (US)

(72) Inventors: Viraj SRIVASTAVA, New Delhi (IN); Minal Nitin DANI, Bangalore (IN); Karel MARIK, Revnice (CZ); Amrutha Madhav KALIBHAT, Bengaluru (IN)

(21) Appl. No.: 18/456,908

(22) Filed: Aug. 28, 2023

(51) Int. Cl. G06F 11/07; G06F 11/00; G06F 11/30; G06F 11/34

(52) U.S. Cl. CPC G06F 11/0793; G05B 23/024; G06F 11/008; G06F 11/3055; G06F 11/34; G06N 3/08; G06N 20/00

(57) ABSTRACT

Systems, apparatuses, methods, and computer program products are provided herein. For example, a computer-implemented method may include receiving operational data representing operations of an asset. In some embodiments, the computer-implemented method may include processing the operational data to generate a fault anomaly score for the operational data. In some embodiments, determining, based at least in part on the fault anomaly score, whether the operational data is indicative of the asset being associated with at least one fault. In some embodiments, the computer-implemented method may include generating, based at least in part on applying the operational data to a fault classification model, fault data. In some embodiments, the computer-implemented method may include generating, based at least in part on applying the fault data to a fault impact model, fault impact data. In some embodiments, the computer-implemented method may include initiating performance of one or more fault optimization actions.

### TECHNOLOGICAL FIELD

Embodiments of the present disclosure relate generally to systems, apparatuses, methods, and computer program products for optimizing one or more assets.

### BACKGROUND

Applicant has identified many technical challenges and difficulties associated with systems, apparatuses, methods, and computer program products for optimizing one or more assets. Through applied effort, ingenuity, and innovation, Applicant has solved problems related to systems, apparatuses, methods, and computer program products for optimizing one or more assets by developing solutions embodied in the present disclosure, which are described in detail below.

### BRIEF SUMMARY

Various embodiments described herein relate to systems, apparatuses, methods, and computer program products for optimizing one or more assets.

In accordance with one aspect of the disclosure, a computer-implemented method is provided. In some embodiments, the computer-implemented method may include receiving operational data representing operations of an asset. In some embodiments, the computer-implemented method may include processing the operational data to generate a fault anomaly score for the operational data. In some embodiments, the computer-implemented method may include determining, based at least in part on the fault anomaly score, whether the operational data is indicative of the asset being associated with at least one fault. In some embodiments, the computer-implemented method may include in accordance with a determination that the operational data is indicative of the asset being associated with the at least one fault generating, based at least in part on applying the operational data to a fault classification model, fault data. In some embodiments, the computer-implemented method may include in accordance with a determination that the operational data is indicative of the asset being associated with the at least one fault generating, based at least in part on applying the fault data to a fault impact model, fault impact data. In some embodiments, the fault impact model comprises a reinforcement learning model. In some embodiments, the computer-implemented method may include in accordance with a determination that the operational data is indicative of the asset being associated with the at least one fault initiating performance of one or more fault optimization actions based at least in part on the fault impact data.

In some embodiments, the one or more fault optimization actions include at least one short-term fault optimization action.

In some embodiments, the one or more fault optimization actions include at least one long-term fault optimization action.

In some embodiments, the computer-implemented method may include performing a first training of the fault impact model. In some embodiments, the first training of the fault impact model comprises identifying a historical dataset. In some embodiments, the historical dataset comprises labeled data. In some embodiments, the first training of the fault impact model comprises training the fault impact model using a machine learning technique based at least in part on the historical dataset.

In some embodiments, the machine learning technique is a supervised machine learning technique.

In some embodiments, the computer-implemented method may include performing a second training of the fault impact model. In some embodiments, the second training of the fault impact model comprises training the fault impact model based at least in part on the fault data.

In some embodiments, the fault data is unlabeled data.

In some embodiments, the fault data indicates a fault type associated with the at least one fault.

In some embodiments, the fault anomaly score is generated at least in part by performing a principal component analysis technique.

In some embodiments, the at least one fault is at least one of a transient fault, an intermittent fault, or a permanent fault.

In accordance with another aspect of the disclosure, an apparatus is provided. In some embodiments, the apparatus may include at least one processor and at least one non-transitory memory including computer-coded instructions thereon. In some embodiments, the computer-coded instructions, with the at least one processor, cause the apparatus to receive operational data representing operations of an asset. In some embodiments, the computer-coded instructions, with the at least one processor, cause the apparatus to process the operational data to generate a fault anomaly score for the operational data. In some embodiments, the computer-coded instructions, with the at least one processor, cause the apparatus to determine, based at least in part on the fault anomaly score, whether the operational data is indicative of the asset being associated with at least one fault. In some embodiments, the computer-coded instructions, with the at least one processor, cause the apparatus to in accordance with a determination that the operational data is indicative of the asset being associated with the at least one fault generate, based at least in part on applying the operational data to a fault classification model, fault data. In some embodiments, the computer-coded instructions, with the at least one processor, cause the apparatus to in accordance with a determination that the operational data is indicative of the asset being associated with the at least one fault generate, based at least in part on applying the fault data to a fault impact model, fault impact data. In some embodiments, the fault impact model comprises a reinforcement learning model. In some embodiments, the computer-coded instructions, with the at least one processor, cause the apparatus to in accordance with a determination that the operational data is indicative of the asset being associated with the at least one fault initiate performance of one or more fault optimization actions based at least in part on the fault impact data.

In some embodiments, the one or more fault optimization actions include at least one short-term fault optimization action.

In some embodiments, the one or more fault optimization actions include at least one long-term fault optimization action.

In some embodiments, the computer-coded instructions, with the at least one processor, cause the apparatus to perform a first training of the fault impact model. In some embodiments, the first training of the fault impact model comprises identifying a historical dataset. In some embodiments, the historical dataset comprises labeled data. In some embodiments, the first training of the fault impact model comprises training the fault impact model using a machine learning technique based at least in part on the historical dataset.

In some embodiments, the machine learning technique is a supervised machine learning technique.

In some embodiments, the computer-coded instructions, with the at least one processor, cause the apparatus to perform a second training of the fault impact model. In some embodiments, the second training of the fault impact model comprises training the fault impact model based at least in part on the fault data.

In some embodiments, the fault data is unlabeled data.

In some embodiments, the fault data indicates a fault type associated with the at least one fault.

In some embodiments, the fault anomaly score is generated at least in part by performing a principal component analysis technique.

In some embodiments, the at least one fault is at least one of a transient fault, an intermittent fault, or a permanent fault.

In accordance with another aspect of the disclosure, a computer program product is provided. In some embodiments, the computer program product includes at least one non-transitory computer-readable storage medium having computer program code stored thereon. In some embodiments, the computer program code, in execution with at least one processor, configures the computer program product for receiving operational data representing operations of an asset. In some embodiments, the computer program code, in execution with at least one processor, configures the computer program product for processing the operational data to generate a fault anomaly score for the operational data. In some embodiments, the computer program code, in execution with at least one processor, configures the computer program product for determining, based at least in part on the fault anomaly score, whether the operational data is indicative of the asset being associated with at least one fault. In some embodiments, the computer program code, in execution with at least one processor, configures the computer program product for in accordance with a determination that the operational data is indicative of the asset being associated with the at least one fault generating, based at least in part on applying the operational data to a fault classification model, fault data. In some embodiments, the computer program code, in execution with at least one processor, configures the computer program product for in accordance with a determination that the operational data is indicative of the asset being associated with the at least one fault generating, based at least in part on applying the fault data to a fault impact model, fault impact data. In some embodiments, the fault impact model comprises a reinforcement learning model. In some embodiments, the computer program code, in execution with at least one processor, configures the computer program product for in accordance with a determination that the operational data is indicative of the asset being associated with the at least one fault initiating performance of one or more fault optimization actions based at least in part on the fault impact data.

In some embodiments, the one or more fault optimization actions include at least one short-term fault optimization action.

In some embodiments, the one or more fault optimization actions include at least one long-term fault optimization action.

In some embodiments, the computer program code, in execution with at least one processor, configures the computer program product for performing a first training of the fault impact model. In some embodiments, the first training of the fault impact model comprises identifying a historical dataset. In some embodiments, the historical dataset comprises labeled data. In some embodiments, the first training of the fault impact model comprises training the fault impact model using a machine learning technique based at least in part on the historical dataset.

In some embodiments, the machine learning technique is a supervised machine learning technique.

In some embodiments, the computer program code, in execution with at least one processor, configures the computer program product for performing a second training of the fault impact model. In some embodiments, the second training of the fault impact model comprises training the fault impact model based at least in part on the fault data.

In some embodiments, the fault data is unlabeled data.

In some embodiments, the fault data indicates a fault type associated with the at least one fault.

In some embodiments, the fault anomaly score is generated at least in part by performing a principal component analysis technique.

In some embodiments, the at least one fault is at least one of a transient fault, an intermittent fault, or a permanent fault.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Reference will now be made to the accompanying drawings. The components illustrated in the figures may or may not be present in certain embodiments described herein. Some embodiments may include fewer (or more) components than those shown in the figures in accordance with an example embodiment of the present disclosure.

FIG. 1 illustrates an exemplary block diagram of an environment in which embodiments of the present disclosure may operate;

FIG. 2 illustrates an exemplary block diagram of an example apparatus that may be specially configured in accordance with an example embodiment of the present disclosure;

FIG. 3 illustrates an example a system architecture in accordance with one or more embodiments of the present disclosure;

FIG. 4 illustrates an example graphical representation in accordance with one or more embodiments of the present disclosure;

FIG. 5 illustrates another example graphical representation in accordance with one or more embodiments of the present disclosure; and

FIG. 6 illustrates a flowchart of an example method in accordance with one or more embodiments of the present disclosure.

### DETAILED DESCRIPTION

Some embodiments of the present disclosure will now be described more fully herein with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

The use of the term “circuitry” as used herein with respect to components of a system, or an apparatus should be understood to include particular hardware configured to perform the functions associated with the particular circuitry as described herein. The term “circuitry” should be understood broadly to include hardware and, in some embodiments, software for configuring the hardware. For example, in some embodiments, “circuitry” may include processing circuitry, communication circuitry, input/output circuitry, and the like. In some embodiments, other elements may provide or supplement the functionality of particular circuitry. Alternatively or additionally, in some embodiments, other elements of a system and/or apparatus described herein may provide or supplement the functionality of another particular set of circuitry. For example, a processor may provide processing functionality to any of the sets of circuitry, a memory may provide storage functionality to any of the sets of circuitry, communications circuitry may provide network interface functionality to any of the sets of circuitry, and/or the like.

### Overview

Example embodiments disclosed herein address technical problems associated with systems, apparatuses, methods, and computer program products for optimizing one or more assets. As would be understood by one skilled in the field to which this disclosure pertains, there are numerous example scenarios in which a user may use systems, apparatuses, methods, and computer program products for optimizing one or more assets.

In many applications, systems, apparatuses, methods, and computer program products for optimizing one or more assets are necessary. For example, it may be necessary to optimize one or more assets so that one or more faults associated with the asset may be detected and/or classified. As another example, it may be necessary to optimize one or more assets to remedy a fault by initiate one or more fault optimization actions associated with the one or more assets, such as a short-term fault optimization action (e.g., immediately replace an air cooling unit) and/or a long-term fault optimization action (e.g., replace an air cooling unit at a later date).

Example solutions for detecting, classifying, and/or remedying one or more faults associated with one or more assets include, for example, rules based modeling. However, a rules based modeling solution may require the selection of a large number of parameters and thresholds and, as a result, may be inaccurate for complex systems (e.g., such as a hydrocarbon processing plant). Example solutions for detecting, classifying, and/or remedying one or more faults associated with one or more assets include, for example, estimation methods, such as autoencoders. However, estimation based solutions are often unable to detect non-linear faults. Example solutions for detecting, classifying, and/or remedying one or more faults associated with one or more assets include, for example, statistical methods. However, a statistical method based solution may be susceptible to indicating a large number of false positives. Example solutions for detecting, classifying, and/or remedying one or more faults associated with one or more assets include, for example, a time series based analysis. However, a time series based analysis solution may require substantial computing power such that it may be impractical for complex systems. Example solutions for detecting, classifying, and/or remedying one or more faults associated with one or more assets include, for example, using model predictive control. However, a model predictive control based solution may require a highly complex model that requires significant tuning and retuning, which may result in inaccurate results. Accordingly, there is a need for systems, apparatuses, methods, and computer program products capable of detecting, classifying, and/or remedying one or more faults associated with one or more assets in an effective, consistent, and streamlined manner.

Thus, to address these and/or other issues related to systems, apparatuses, methods, and computer program products for optimizing one or more assets, example systems, apparatuses, methods, and computer program product for optimizing one or more assets are disclosed herein. For example, an embodiment in this disclosure, described in greater detail below, includes a computer-implemented method that includes receiving operational data representing operations of an asset. In some embodiments, the computer-implemented method may include processing the operational data to generate a fault anomaly score for the operational data. In some embodiments, determining, based at least in part on the fault anomaly score, whether the operational data is indicative of the asset being associated with at least one fault. In some embodiments, the computer-implemented method may include generating, based at least in part on applying the operational data to a fault classification model, fault data. In some embodiments, the computer-implemented method may include generating, based at least in part on applying the fault data to a fault impact model, fault impact data. In some embodiments, the fault impact model comprises a reinforcement learning model. In some embodiments, the computer-implemented method may include initiating performance of one or more fault optimization actions.

### Example Systems and Apparatuses

Embodiments of the present disclosure herein include systems, apparatuses, methods, and computer program products configured for optimizing one or more assets. It should be readily appreciated that the embodiments of the apparatus, systems, methods, and computer program product described herein may be configured in various additional and alternative manners in addition to those expressly described herein.

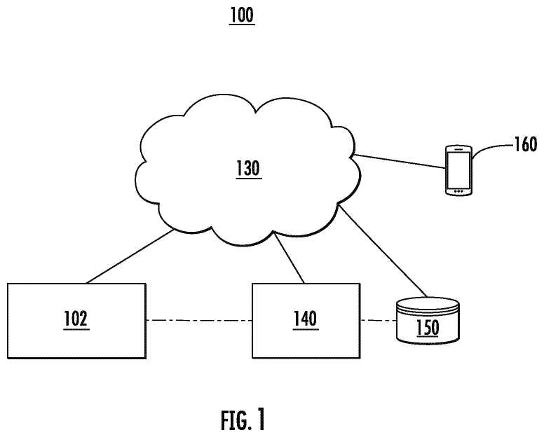

FIG. 1 illustrates an exemplary block diagram of an environment 100 in which embodiments of the present disclosure may operate. Specifically, FIG. 1 illustrates an asset 102. In some embodiments, for example, the asset 102 may be any type of plant associated with a user associated with the environment 100. In this regard, the asset 102 may, for example, be a processing plant that receives and processes ingredients as inputs to create a processed product, such as a hydrocarbon processing plant, a refinery, a pulp and paper plant, a chemical plant, an alumina plant, a drilling facility, a fracking field, and/or the like. Additionally or alternatively, for example, the asset 102 may include at least one building. In this regard, the asset 102 may, for example, be an industrial building, office building, building associated with a plant, and/or the like.

The asset 102 in some embodiments includes any number of individual components. The components of the asset 102 may perform a particular function during operation of the asset 102. For example, the components may include one or more well components, fracking components, crude processing components, hydrotreating components, isomerization components, vapor recovery components, fluid catalytic cracking components, hydrocracking components, aromatics reduction components, visbreaker components, storage tank components, blender components, pump components, flash venting components, compressor components, cooler components (e.g., air cooler components), sensor components, storage components, flare components, heating, ventilation, and air (HVAC) components, air handling components, lighting components, and/or the like that perform a particular operation for transforming, storing, releasing, and/or otherwise handling one or more input ingredient(s) (e.g., hydrocarbons, gases, etc.). In this regard, for example, the individual components of an asset may include components associated with a particular process performed by the asset.

In some embodiments, each individual component of the asset 102 is associated with a determinable location. The determinable location of a particular component in some embodiments represents an absolute position (e.g., GPS coordinates, latitude, and longitude locations, and/or the like) or a relative position (e.g., a point representation of the location of a component from a local origin point corresponding to the asset 102). In some embodiments, a component includes or otherwise is associated with a location sensor and/or software-driven location services that provide the location data representing the location corresponding to that component. In other embodiments the location of a component is stored and/or otherwise predetermined within a software environment, provided by a user and/or otherwise determinable to one or more systems.

Additionally or alternatively, in some embodiments, the asset 102 itself is associated with a determinable location. The determinable location of the asset 102 in some embodiments represents an absolute position (e.g., GPS coordinates, latitude and longitude locations, an address, and/or the like) or a relative position of the asset 102 (e.g., an identifier representing the location of the asset 102 as compared to one or more other assets, one or more other buildings, an enterprise headquarters, or general description in the world for example based at least in part on continent, state, or other definable region). In some embodiments, the asset 102 includes or otherwise is associated with a location sensor and/or software-driven location services that provide the location data corresponding to the asset 102. In other embodiments, the location of the asset 102 is stored and/or otherwise determinable to one or more systems.

The network 130 may be embodied in any of a myriad of network configurations. In some embodiments, the network 130 may be a public network (e.g., the Internet). In some embodiments, the network 130 may be a private a private network (e.g., an internal localized, or closed-off network between particular devices). In some other embodiments, the network 130 may be a hybrid network (e.g., a network enabling internal communications between particular connected devices and external communications with other devices). In various embodiments, the network 130 may include one or more base station(s), relay(s), router(s), switch(es), cell tower(s), communications cable(s), routing station(s), and/or the like. In various embodiments, components of the environment 100 may be communicatively coupled to transmit data to and/or receive data from one another over the network 130. Such configuration(s) include, without limitation, a wired or wireless Personal Area Network (PAN), Local Area Network (LAN), Metropolitan Area Network (MAN), Wide Area Network (WAN), and/or the like.

In some embodiments, the environment 100 may include an asset optimization system 140. In some embodiments, for example, the asset optimization system 140 may be configured to optimize one or more assets (e.g., asset 102). The asset optimization system 140 may be electronically and/or communicatively coupled to the asset 102, individual components of the asset 102, one or more databases 150, and/or one or more user devices 160. The asset optimization system 140 may be located remotely, in proximity of, and/or within the asset 102. In some embodiments, the asset optimization system 140 is configured via hardware, software, firmware, and/or a combination thereof, to perform data intake of one or more types of data associated with one or more of the asset 102. Additionally or alternatively, in some embodiments, the asset optimization system 140 is configured via hardware, software, firmware, and/or a combination thereof, to generate and/or transmit command(s) that control, adjust, or otherwise impact operations of one or more of the asset 102 or specific component(s) thereof, for example for controlling one or more operations of the asset 102. Additionally or alternatively still, in some embodiments, the asset optimization system 140 is configured via hardware, software, firmware, and/or a combination thereof, to perform data reporting and/or other data output process(es) associated with monitoring or otherwise analyzing operations of one or more of the asset 102 or specific component(s) thereof, for example for generating and/or outputting report(s) corresponding to the operations performed via the asset 102. For example, in various embodiments, the asset optimization system 140 may be configured to execute and/or perform one or more operations and/or functions described herein.

The one or more databases 150 may be configured to receive, store, and/or transmit data. In some embodiments, the one or more databases 150 may be associated with operational data associated with the asset 102. In some embodiments, the operational data may be received from the asset 102. In this regard, for example, the asset 102 may have one or more sensors that capture operational data and/or one or more datastores that store operational data. In some embodiments, the operational data may be received from the asset optimization system 140. In this regard, for example, the asset optimization system 140 may be configured to identify operational data associated with the asset 102. In some embodiments, the one or more databases 150 may be associated with operational data received from the asset 102 and/or the asset optimization system 140 in real-time. Additionally or alternatively, the one or more databases 150 may be associated with operational data received from the asset 102 and/or the asset optimization system 140 on a periodic basis (e.g., the operational data may be received from the asset 102 and/or the asset optimization system 140 once per day). Additionally or alternatively, the one or more databases 150 may be associated with historical physical representation received from the asset 102 and/or the asset optimization system 140 (e.g., physical representation previously received from the asset 102 and/or the asset optimization system 140). Additionally or alternatively, the one or more databases 150 may be associated with operational data received from the asset 102 and/or the asset optimization system 140 in response to a request for the operational data. Additionally or alternatively, the one or more databases 150 may be associated with operational data inputted (e.g., by a user) into the asset optimization system 140 and/or the one or more user devices 160.

The one or more user devices 160 may be associated with users of the asset optimization system 140. In various embodiments, the asset optimization system 140 may generate and/or transmit a message, alert, or indication to a user via a user device 160. Additionally, or alternatively, a user device 160 may be utilized by a user to remotely access the asset optimization system 140. This may be by, for example, an application operating on the user device 160. A user may access the asset optimization system 140 remotely, including one or more visualizations, reports, and/or real-time displays.

Additionally, while FIG. 1 illustrates certain components as separate, standalone entities communicating over the network 130, various embodiments are not limited to this configuration. In other embodiments, one or more components may be directly connected and/or share hardware or the like. For example, in some embodiments, the asset optimization system 140 may include the one or more databases 150, which may collectively be located in or at the asset 102.

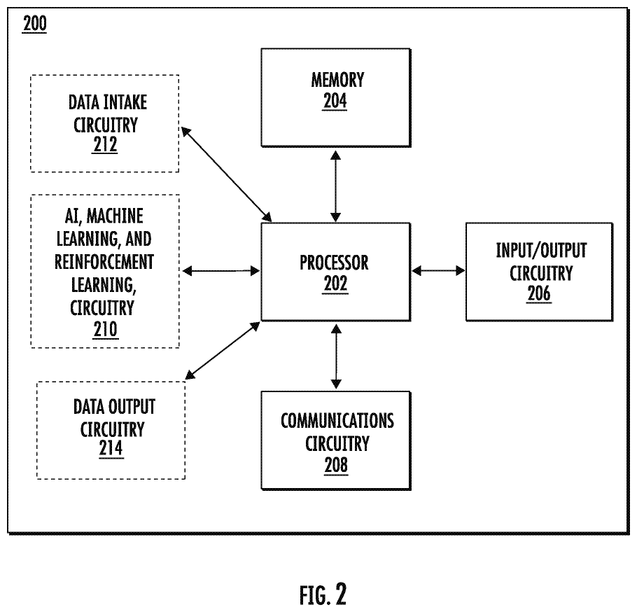

FIG. 2 illustrates an exemplary block diagram of an example apparatus that may be specially configured in accordance with an example embodiment of the present disclosure. Specifically, FIG. 2 depicts an example computing apparatus 200 (“apparatus 200”) specially configured in accordance with at least some example embodiments of the present disclosure. For example, the computing apparatus 200 may be embodied as one or more of a specifically configured personal computing apparatus, a specifically configured cloud based computing apparatus, a specifically configured embedded computing device (e.g., configured for edge computing, and/or the like). Examples of an apparatus 200 may include, but is not limited to, an asset optimization system 140, the one or more databases 150, and/or a user device 160. The apparatus 200 includes processor 202, memory 204, input/output circuitry 206, communications circuitry 208, and/or optional artificial intelligence (“AI”), machine learning, and reinforcement learning circuitry 210. In some embodiments, the apparatus 200 is configured to execute and perform the operations described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), memory (ies), circuitry (ies), and/or the like to perform their associated functions such that duplicate hardware is not required for each set of circuitry.

In various embodiments, such as computing apparatus 200 of an asset optimization system 140 or of a user device 160 may refer to, for example, one or more computers, computing entities, desktop computers, mobile phones, tablets, phablets, notebooks, laptops, distributed systems, servers, or the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein. In one embodiment, these functions, operations, and/or processes can be performed on data, content, information, and/or similar terms used herein. In this regard, the apparatus 200 embodies a particular, specially configured computing entity transformed to enable the specific operations described herein and provide the specific advantages associated therewith, as described herein.

Processor 202 or processor circuitry 202 may be embodied in a number of different ways. In various embodiments, the use of the terms “processor” should be understood to include a single core processor, a multi-core processor, multiple processors internal to the apparatus 200, and/or one or more remote or “cloud” processor(s) external to the apparatus 200. In some example embodiments, processor 202 may include one or more processing devices configured to perform independently. Alternatively, or additionally, processor 202 may include one or more processor(s) configured in tandem via a bus to enable independent execution of operations, instructions, pipelining, and/or multithreading.

In an example embodiment, the processor 202 may be configured to execute instructions stored in the memory 204 or otherwise accessible to the processor. Alternatively, or additionally, the processor 202 may be configured to execute hard-coded functionality. As such, whether configured by hardware or software methods, or by a combination thereof, processor 202 may represent an entity (e.g., physically embodied in circuitry) capable of performing operations according to embodiments of the present disclosure while configured accordingly. Alternatively, or additionally, processor 202 may be embodied as an executor of software instructions, and the instructions may specifically configure the processor 202 to perform the various algorithms embodied in one or more operations described herein when such instructions are executed. In some embodiments, the processor 202 includes hardware, software, firmware, and/or a combination thereof that performs one or more operations described herein.

In some embodiments, the processor 202 (and/or co-processor or any other processing circuitry assisting or otherwise associated with the processor) is/are in communication with the memory 204 via a bus for passing information among components of the apparatus 200.

Memory 204 or memory circuitry 204 may be non-transitory and may include, for example, one or more volatile and/or non-volatile memories. In some embodiments, the memory 204 includes or embodies an electronic storage device (e.g., a computer readable storage medium). In some embodiments, the memory 204 is configured to store information, data, content, applications, instructions, or the like, for enabling an apparatus 200 to carry out various operations and/or functions in accordance with example embodiments of the present disclosure.

Input/output circuitry 206 may be included in the apparatus 200. In some embodiments, input/output circuitry 206 may provide output to the user and/or receive input from a user. The input/output circuitry 206 may be in communication with the processor 202 to provide such functionality. The input/output circuitry 206 may comprise one or more user interface(s). In some embodiments, a user interface may include a display that comprises the interface(s) rendered as a web user interface, an application user interface, a user device, a backend system, or the like. In some embodiments, the input/output circuitry 206 also includes a keyboard, a mouse, a joystick, a touch screen, touch areas, soft keys a microphone, a speaker, or other input/output mechanisms. The processor 202 and/or input/output circuitry 206 comprising the processor may be configured to control one or more operations and/or functions of one or more user interface elements through computer program instructions (e.g., software and/or firmware) stored on a memory accessible to the processor (e.g., memory 204, and/or the like). In some embodiments, the input/output circuitry 206 includes or utilizes a user-facing application to provide input/output functionality to a computing device and/or other display associated with a user.

Communications circuitry 208 may be included in the apparatus 200. The communications circuitry 208 may include any means such as a device or circuitry embodied in either hardware or a combination of hardware and software that is configured to receive and/or transmit data from/to a network and/or any other device, circuitry, or module in communication with the apparatus 200. In some embodiments the communications circuitry 208 includes, for example, a network interface for enabling communications with a wired or wireless communications network. Additionally or alternatively, the communications circuitry 208 may include one or more network interface card(s), antenna(s), bus(es), switch(es), router(s), modem(s), and supporting hardware, firmware, and/or software, or any other device suitable for enabling communications via one or more communications network(s). In some embodiments, the communications circuitry 208 may include circuitry for interacting with an antenna(s) and/or other hardware or software to cause transmission of signals via the antenna(s) and/or to handle receipt of signals received via the antenna(s). In some embodiments, the communications circuitry 208 enables transmission to and/or receipt of data from a user device, one or more sensors, and/or other external computing device(s) in communication with the apparatus 200.

Data intake circuitry 212 may be included in the apparatus 200. The data intake circuitry 212 may include hardware, software, firmware, and/or a combination thereof, designed and/or configured to capture, receive, request, and/or otherwise gather data associated with operations of the asset 102. In some embodiments, the data intake circuitry 212 includes hardware, software, firmware, and/or a combination thereof, that communicates with one or more sensor(s) component(s), and/or the like within the asset 102 to receive particular data associated with such operations of the asset 102. Additionally or alternatively, in some embodiments, the data intake circuitry 212 includes hardware, software, firmware, and/or a combination thereof, that retrieves particular data associated with the asset 102 from one or more data repository/repositories accessible to the apparatus 200.

AI, machine learning, and reinforcement learning circuitry 210 may be included in the apparatus 200. The AI, machine learning, and reinforcement learning circuitry 210 may include hardware, software, firmware, and/or a combination thereof designed and/or configured to request, receive, process, generate, and transmit data, data structures, control signals, and electronic information for training and executing a trained AI, machine learning model, and/or reinforcement learning model configured to facilitating the operations and/or functionalities described herein. For example, in some embodiments the AI, machine learning, and reinforcement learning circuitry 210 includes hardware, software, firmware, and/or a combination thereof, that identifies training data and/or utilizes such training data for training a particular machine learning model, AI, reinforcement learning model, and/or other model to generate particular output data based at least in part on learnings from the training data. Additionally or alternatively, in some embodiments, the AI, machine learning, and reinforcement learning circuitry 210 includes hardware, software, firmware, and/or a combination thereof, that embodies or retrieves a trained machine learning model, AI, reinforcement learning model, and/or other specially configured model utilized to process inputted data. Additionally or alternatively, in some embodiments, the AI, machine learning, and reinforcement learning circuitry 210 includes hardware, software, firmware, and/or a combination thereof that processes received data utilizing one or more algorithm(s), function(s), subroutine(s), and/or the like, in one or more pre-processing and/or subsequent operations that need not utilize a machine learning, reinforcement learning model, and/or AI model.

Data output circuitry 214 may be included in the apparatus 200. The data output circuitry 214 may include hardware, software, firmware, and/or a combination thereof, that configures and/or generates an output based at least in part on data processed by the apparatus 200. In some embodiments, the data output circuitry 214 includes hardware, software, firmware, and/or a combination thereof, that generates a particular report based at least in part on the processed data, for example where the report is generated based at least in part on a particular reporting protocol. Additionally or alternatively, in some embodiments, the data output circuitry 214 includes hardware, software, firmware, and/or a combination thereof, that configures a particular output data object, output data file, and/or user interface for storing, transmitting, and/or displaying. For example, in some embodiments, the data output circuitry 214 generates and/or specially configures a particular data output for transmission to another system sub-system for further processing. Additionally or alternatively, in some embodiments, the data output circuitry 214 includes hardware, software, firmware, and/or a combination thereof, that causes rendering of a specially configured user interface based at least in part on data received by and/or processing by the apparatus 200.

In some embodiments, two or more of the sets of circuitries 202-214 are combinable. Alternatively, or additionally, one or more of the sets of circuitry 202-214 perform some or all of the operations and/or functionality described herein as being associated with another circuitry. In some embodiments, two or more of the sets of circuitry 202-214 are combined into a single module embodied in hardware, software, firmware, and/or a combination thereof. For example, in some embodiments, one or more of the sets of circuitry, for example the AI, machine learning, and reinforcement learning circuitry 210, may be combined with the processor 202, such that the processor 202 performs one or more of the operations described herein with respect the AI, machine learning, and reinforcement learning circuitry 210.

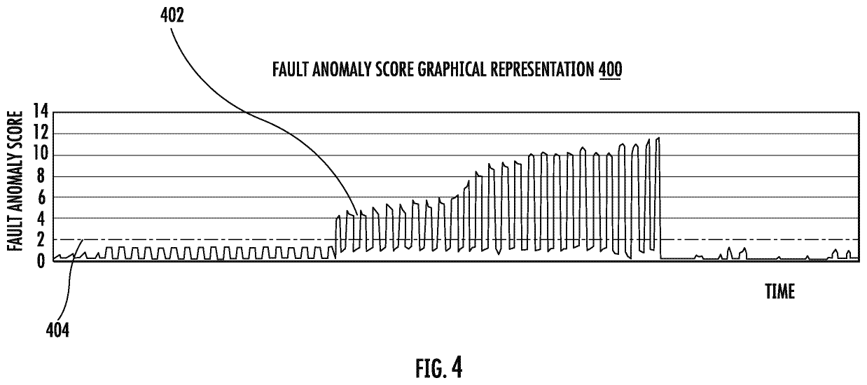

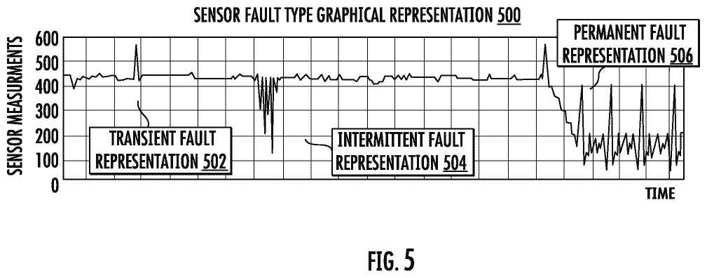

With reference to FIGS. 1-5, in some embodiments, the asset optimization system 140 may be configured to receive operational data. In some embodiments, the operational data may be representative of operations of an asset 102. In some embodiments, the operational data may be received by the asset optimization system 140 from the asset 102. In some embodiments, at least a portion of the operational data may be captured by one or more sensor components of the asset 102.

In some embodiments, the operational data may include one or more of asset component data, asset efficiency data, flow rate data, temperature data, pressure data, and/or weather data. For example, the asset component data may indicate whether the asset 102 has one or more well components, fracking components, crude processing components, hydrotreating components, isomerization components, vapor recovery components, fluid catalytic cracking components, hydrocracking components, aromatics reduction components, visbreaker components, storage tank components, blender components, pump components, flash venting components, compressor components, cooler components (e.g., air cooler components), sensor components, storage components, flare components, HVAC components, air handling components, lighting components, and/or the like. As another example, the asset efficiency data may indicate the efficiency of one or more processes performed by the asset 102 and/or one or more processes performed by one or more components of the asset 102 (e.g., a compressor component).

As another example, flow rate data may indicate the flow rate of various fluids in different locations throughout the asset 102 (e.g., a flow rate of air in an air handling component of the asset 102). As another example, temperature data may indicate the temperature at various locations in the asset 102 (e.g., a temperature associated with a HVAC component). As another example, the pressure data may indicate the pressure at various locations in the asset 102. As another example, the weather data may indicate the weather around the asset 102 (e.g., a temperature around the asset 102).

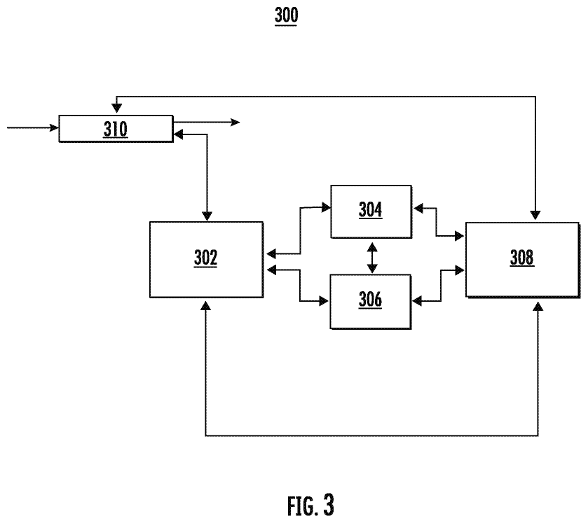

In some embodiments, the asset optimization system 140 may be configured to process the operational data to generate a fault anomaly score for the operational data. In some embodiments, the asset optimization system 140 may be configured to process the operational data to generate the fault anomaly score at least in part by applying the operational data to a fault detection model 302 (e.g., as illustrated in the system architecture 300 of FIG. 3). In some embodiments, the fault detection model 302 may comprise one or more of a statistical model, an algorithmic model, a control systems model, a first principles model, a reinforcement learning model, and/or a machine learning model (e.g., using AI, machine learning, and reinforcement learning circuitry 210).

In some embodiments, the fault anomaly score may be a value representative of a likelihood that the operational data is indicative of the asset 102 being associated with at least one fault (e.g., a HVAC component of the asset 102 is affected by a fault). In some embodiments, the greater the value of the fault anomaly score the greater likelihood that the asset 102 is associated with at least one fault. For example, a fault anomaly score of 6 would indicate that there is a greater likelihood that the asset 102 is associated with at least one fault than a fault anomaly score of 1.

In some embodiments, the asset optimization system 140 may be configured to determine that the operational data is indicative of the asset 102 being associated with at least one fault based at least in part on comparing the fault anomaly score to a fault anomaly score threshold. In this regard, for example, if the fault anomaly score is greater than the fault anomaly score threshold, the asset optimization system 140 may determine that the operational data is indicative of the asset 102 being associated with at least one fault (e.g., if the fault anomaly score is 8 and the fault anomaly score threshold is 1.8). Similarly, for example, if the fault anomaly score is less than or equal to the fault anomaly score threshold, the asset optimization system 140 may determine that the operational data is not indicative of the asset 102 being associated with at least one fault (e.g., if the fault anomaly score is 1 and the fault anomaly score threshold is 1.8).

In some embodiments, the asset optimization system 140 may be configured to train the fault detection model 302 to generate the fault anomaly score for the operational data. In this regard, for example, the asset optimization system 140 may be configured to identify a historical normal dataset. In some embodiments, the historical normal dataset may include historical operational data associated with the asset 102. In some embodiments, the historical operational data may be data representative of operations of the asset 102 when the asset 102 and/or the one or more components of the asset 102 were associated with a normal operating state (e.g., when the asset 102 and/or the one or more components of the asset 102 were not associated with a fault). In some embodiments, using the historical normal dataset, the asset optimization system 140 may train the fault detection model 302 using a principal component analysis technique. Additionally or alternatively, using the historical normal dataset, the asset optimization system 140 may train the fault detection model 302 using an encoder and/or decoder technique.

In some embodiments, the asset optimization system 140 may be configured to generate a fault anomaly score graphical representation 400 at least in part on the operational data and/or the fault anomaly score. In this regard, for example, the fault anomaly score graphical representation 400 may include a fault score representation 402. Additionally or alternatively, the fault anomaly score graphical representation 400 may include a fault anomaly score threshold representation 404.

In some embodiments, the asset optimization system 140 may be configured to perform data augmentation and/or data annotation on the operational data at least in part by applying the operational data to a fault annotation model 304. In some embodiments, the fault annotation model 304 may comprise one or more of a statistical model, an algorithmic model, a control systems model, a first principles model, a reinforcement learning model, and/or a machine learning model (e.g., using AI, machine learning, and reinforcement learning circuitry 210). In this regard, the fault annotation model 304 may be configured to perform data augmentation and/or data annotation on the operational data by performing one or more of a jittering technique, a scaling technique, a magnitude warping technique, a time warping technique, a rotation technique, a permutation technique, a random sampling technique, a rotation and permutation technique, and/or the like.

In some embodiments, in accordance with a determination that the operational data is indicative of the asset being associated with at least one fault (e.g., when the fault anomaly score is above the fault anomaly score threshold), the asset optimization system 140 may be configured to generate fault data. In some embodiments, the asset optimization system 140 may be configured to generate the fault data at least in part by applying the operational data to a fault classification model 306 (e.g., after data augmentation and/or data annotation has been performed on the operational data by the fault annotation model 304). In some embodiments, the fault classification model 306 may comprise one or more of a statistical model, an algorithmic model, a control systems model, a first principles model, a reinforcement learning model, and/or a machine learning model (e.g., using AI, machine learning, and reinforcement learning circuitry 210). In this regard, for example, the fault classification model 306 may be configured to generate the fault data using one or more of a random forest technique and/or a long short-term memory (LSTM) technique.

In some embodiments, the fault data may be representative of a particular type of fault associated with the at least one fault associated with the asset 102 and/or components of the asset 102 from a plurality of fault types. In this regard, for example, the asset 102 may be configured such that it may be associated with one or more of a plurality of fault types. For example, the asset 102 may be associated with an air handling unit fault type (e.g., an air handling component fault type that include a fault associated with the coil of an air handling unit). As another example, the asset 102 may be associated with a HVAC fault type. As another example, a sensor component of the asset 102 may be associated with a sensor fault type. In this regard, based at least in part on the operational data, the fault classification model 306 may be configured to classify the at least one fault into an appropriate fault type out of a plurality of fault types that the asset 102 could be associated with. Said differently, by applying the operational data to the fault classification model 306, the asset optimization system 140 may be configured to identify the particular fault type associated with the at least one fault associated with the asset 102.

In some embodiments, if the fault data indicates that a sensor type component of the asset 102 is associated with a sensor fault type, the fault data may be configured to indicate if the fault associated with a sensor component of the asset 102 is a transient fault, an intermittent fault, and/or a permanent fault. In some embodiments, a transient fault may be a fault associated with a short duration and/or only appears once (e.g., only appears during the short duration). In some embodiments, an intermittent fault may be a fault associated with a sensor component that oscillates between a normal state and a fault state (e.g., an intermittent fault includes a sensor component that is associated with a fault state more than once). In some embodiments, a permanent fault may be a fault in which a sensor component remains in a fault state until action is taken to remedy the fault.

In some embodiments, the asset optimization system 140 may be configured to generate a sensor fault type graphical representation 500 at least in part on the fault data (e.g., when the fault data indicates that there is a fault associated with a sensor component). In this regard, for example, the sensor fault type graphical representation 500 may include a transient fault representation 502. Additionally or alternatively, the sensor fault type graphical representation 500 may include an intermittent fault representation 504. Additionally or alternatively, the sensor fault type graphical representation 500 may include a permanent fault representation 506.

In some embodiments, in accordance with a determination that the operational data is indicative of the asset being associated with at least one fault (e.g., when the fault anomaly score is above the fault anomaly score threshold), the asset optimization system 140 may be configured to generate fault impact data. In some embodiments, the asset optimization system 140 may be configured to generate the fault impact data at least in part by applying the fault data to a fault impact model 308. In some embodiments, the fault impact model 308 may comprise one or more of a statistical model, an algorithmic model, a control systems model, a first principles model, a reinforcement learning model, and/or a machine learning model (e.g., using AI, machine learning, and reinforcement learning circuitry 210). For example, the fault impact model 308 may comprise a reinforcement learning model.

In some embodiments, the fault impact data may be representative of the impact of the at least one fault on the asset 102 and/or the components of the asset 102. For example, the fault impact data may indicate the efficiency of the asset 102 and/or the components of the asset 102 compared to an efficiency of the asset 102 and/or the components of the asset 102 when not associated with the at least one fault (e.g., ninety percent efficiency versus forty percent efficiency). As another example, the fault impact data may indicate a cost associated with operating the asset 102 and/or the components of the asset 102 when the asset 102 is associated with the at least one fault and/or the components of the asset 102 are associated with the at least one fault (e.g., cost due to damage to the asset 102 and/or the components of the asset 102 due to operating when associated with the at least one fault, cost due to lost production capacity of the asset 102 and/or the components of the asset 102 compared to operating without the at least one fault, etc.). As another example, the fault impact data may indicate a cost associated with performing one or more maintenance actions of the asset 102 and/or the components of the asset (e.g., cost of parts to fix the at least one fault, production capacity lost due to having to take the asset 102 and/or components of the asset 102 offline to perform maintenance, etc.). As another example, the fault impact data may indicate an emissions amount associated with the asset 102 and/or the components of the asset 102 compared to an emissions associated with the asset 102 and/or components of the asset 102 when not associated with the at least one fault (e.g., the asset 102 and/or components of the asset 102 may generate greater emissions when associated with the at least one fault).

In some embodiments, the asset optimization system 140 may be configured to perform a first training of the fault impact model 308. In this regard, the asset optimization system 140 may be configured to train the fault impact model 308 by identifying a historical dataset. In some embodiments, the historical dataset may include historical fault data. In some embodiments, the historical fault data may be representative of a particular type of fault associated with the at least one historical fault associated with the asset 102, another asset, one or more components of the asset 102, and/or one or more components of another asset from a plurality of fault types. Additionally or alternatively, the historical dataset may include historical fault impact data. In some embodiments, the historical fault impact data may be representative of the impact at least one fault had on the asset 102, another asset, one or more components of the asset 102, and/or one or more components of another asset from a plurality of fault types.

In some embodiments, the historical dataset may include labeled data. For example, the historical fault data and/or the historical fault impact data may be labeled data. In this regard, the historical fault data and/or the historical fault impact data may have been augmented with one or more labels comprising data about the historical fault data and/or the historical fault impact data. For example, the labels may comprise data indicating date of capture associated with the historical fault data and/or the historical fault impact data, location of capture associated with the historical fault data and/or the historical fault impact data, fault type associated with the historical fault data and/or the historical fault impact data, impact associated with the historical fault data and/or the historical fault impact data, and/or the like.

In some embodiments, the asset optimization system 140 may be configured to train the fault impact model 308 using one or more machine learning techniques. For example, the asset optimization system 140 may be configured to train the fault impact model 308 using a supervised machine learning technique and/or an unsupervised machine learning technique. In some embodiments, the asset optimization system 140 may be configured to train the fault impact model 308 based at least in part on the historical dataset. For example, the asset optimization system 140 may be configured to train the fault impact model 308 based at least in part on the historical fault data and/or the historical fault impact data.

In some embodiments, the asset optimization system 140 may be configured to perform a second training of the fault impact model 308. In some embodiments, the asset optimization system 140 may be configured to train the fault impact model 308 based at least in part on the fault data and/or the fault impact data. In this regard, for example, the asset optimization system 140 may be configured to train the fault impact model 308 using one or more reinforced learning techniques using the fault data and/or the fault impact data.

In some embodiments, the fault data and/or the fault impact data may be unlabeled data (e.g., the fault data and/or the fault impact data have not been augmented with labels). In this regard, the asset optimization system 140 may be able to continually optimize the fault impact model 308 through the training using one or more reinforced learning techniques (e.g., the second training) without reliance on labeled data, such as the historical fault data and/or the historical fault impact data in the historical dataset.

In some embodiments, the asset optimization system 140 may be configured to initiate performance of one or more fault optimization actions based at least in part on the fault impact data (e.g., cause one or more fault optimization actions to occur). For example, the asset optimization system 140 may be configured to initiate performance of one or more fault optimization actions based at least in part on the fault impact data using at least the controller 310. In some embodiments, the one or more fault optimization actions may include at least one short-term fault optimization action. In some embodiments, the short-term fault optimization action may be associated with a short-term time period. In some embodiments, the short-term time period may be a time period associated with the current operations and/or near-term operations of the asset 102. For example, the short-term time period may refer to the operations of the asset on the current hour, day, week, month, year, and/or the like and/or next hour, day, week, month, year, and/or the like.

In some embodiments, the one or more fault optimization actions may include at least one long-term fault optimization actions. In some embodiments, the long-term fault optimization action may be associated with a long-term time period. For example, the long-term time period may refer to the operations of the asset 102 on a future hour, day, week, month, year, etc. In some embodiments, the long-term time period may be a time period associated with the future (e.g., planned) operations of the asset 102 in the long-term time period (e.g., a time period other than the short-term time period) while the short-term time period may be a time period associated with the current operations and/or near-term operations of the asset 102 (e.g., a time period other than the long-term time period).

In some embodiments, for example, the asset optimization system 140 may be configured to initiate a short-term fault optimization action that includes initiating performance of one or more maintenance actions in the short-term time period. For example, the short-term fault optimization action may include one or more maintenance actions to remedy a fault associated with an air handling component in the short-term time period. As another example, the asset optimization system 140 may be configured to initiate a short-term fault optimization action that includes initiating performance of one or more continue operating actions in the short-term time period. For example, the short-term fault optimization action may include one or more continue operating actions in which the asset 102 and/or components of the asset 102 (e.g., a HVAC component) continue to operate as is in the short-term time period and the asset 102 and/or affected by the at least one fault is not remedied within the short-term time period.

In some embodiments, for example, the asset optimization system 140 may be configured to initiate a long-term fault optimization action that includes initiating performance of one or more maintenance actions in the long-term time period. For example, the long-term fault optimization action may include one or more maintenance actions to remedy a fault associated with an air handling component in the long-term time period (e.g., the fault is not remedied in the short-term time period). As another example, the asset optimization system 140 may be configured to initiate a long-term fault optimization action that includes initiating performance of one or more continue operating actions in the long-term time period. For example, the long-term fault optimization action may include one or more continue operating actions in which the asset 102 and/or components of the asset 102 (e.g., a HVAC component) continue to operate as is in the long-term time period and the asset 102 and/or affected by the at least one fault is not remedied within the long-term time period (e.g., the at least one fault may be remedied in the short-term time period or not be remedied in the short-term time period or the long-term time period).

### Example Methods

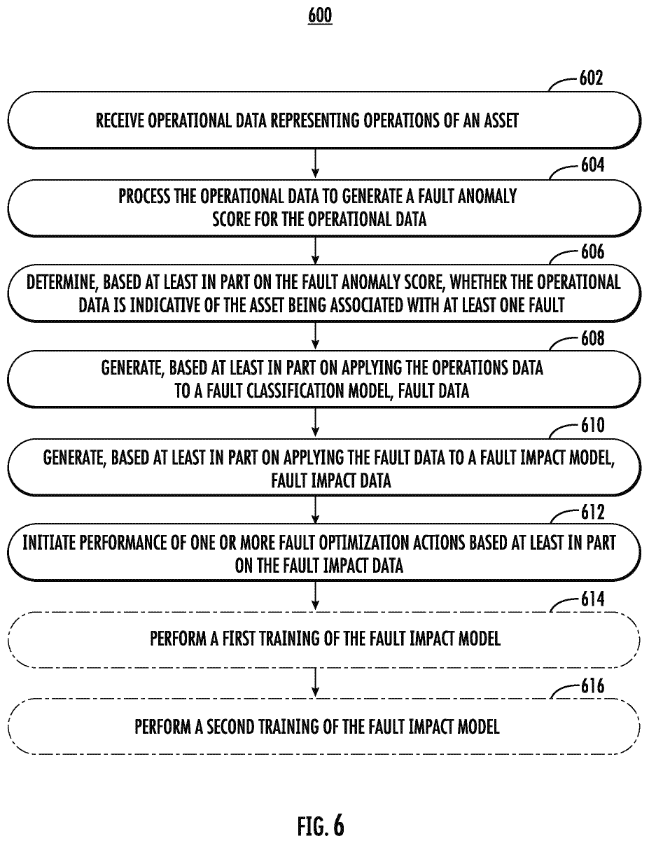

Referring now to FIG. 6, a flowchart providing an example method 600 is illustrated. In this regard, FIG. 6 illustrates operations that may be performed by the asset optimization system 140, the user device 160, the asset 102, and/or the like. In some embodiments, the example method 600 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 600.

As shown in block 602, the method may include receiving operational data representing operations of an asset. As described above, in some embodiments, the operational data may be representative of operations of an asset. In some embodiments, the operational data may be received by the asset optimization system from the asset. In some embodiments, at least a portion of the operational data may be captured by one or more sensor components of the asset.

In some embodiments, the operational data may include one or more of asset component data, asset efficiency data, flow rate data, temperature data, pressure data, and/or weather data. For example, the asset component data may indicate whether the asset has one or more well components, fracking components, crude processing components, hydrotreating components, isomerization components, vapor recovery components, fluid catalytic cracking components, hydrocracking components, aromatics reduction components, visbreaker components, storage tank components, blender components, pump components, flash venting components, compressor components, cooler components (e.g., air cooler components), sensor components, storage components, flare components, HVAC components, air handling components, lighting components, and/or the like. As another example, the asset efficiency data may indicate the efficiency of one or more processes performed by the asset and/or one or more processes performed by one or more components of the asset (e.g., a compressor component).

As another example, flow rate data may indicate the flow rate of various fluids in different locations throughout the asset (e.g., a flow rate of air in an air handling component of the asset). As another example, temperature data may indicate the temperature at various locations in the asset (e.g., a temperature associated with a HVAC component). As another example, the pressure data may indicate the pressure at various locations in the asset. As another example, the weather data may indicate the weather around the asset (e.g., a temperature around the asset).

As shown in block 604, the method may include processing the operational data to generate a fault anomaly score for the operational data. As described above, in some embodiments, the asset optimization system may be configured to process the operational data to generate the fault anomaly score at least in part by applying the operational data to a fault detection model. In some embodiments, the fault detection model may comprise one or more of a statistical model, an algorithmic model, a control systems model, a first principles model, a reinforcement learning model, and/or a machine learning model (e.g., using AI, machine learning, and reinforcement learning circuitry).

In some embodiments, the fault anomaly score may be a value representative of a likelihood that the operational data is indicative of the asset being associated with at least one fault (e.g., a HVAC component of the asset is affected by a fault). In some embodiments, the greater the value of the fault anomaly score the greater likelihood that the asset is associated with at least one fault. For example, a fault anomaly score of 6 would indicate that there is a greater likelihood that the asset is associated with at least one fault than a fault anomaly score of 1.

As shown in block 606, the method may include determining, based at least in part on the fault anomaly score, whether the operational data is indicative of the asset being associated with at least one fault. As described above, in some embodiments, the asset optimization system may be configured to determine that the operational data is indicative of the asset being associated with at least one fault based at least in part on comparing the fault anomaly score to a fault anomaly score threshold. In this regard, for example, if the fault anomaly score is greater than the fault anomaly score threshold, the asset optimization system may determine that the operational data is indicative of the asset being associated with at least one fault (e.g., if the fault anomaly score is 8 and the fault anomaly score threshold is 1.8). Similarly, for example, if the fault anomaly score is less than or equal to the fault anomaly score threshold, the asset optimization system may determine that the operational data is not indicative of the asset being associated with at least one fault (e.g., if the fault anomaly score is 1 and the fault anomaly score threshold is 1.8).

In some embodiments, the asset optimization system may be configured to train the fault detection model to generate the fault anomaly score for the operational data. In this regard, for example, the asset optimization system may be configured to identify a historical normal dataset. In some embodiments, the historical normal dataset may include historical operational data associated with the asset. In some embodiments, the historical operational data may be data representative of operations of the asset when the asset and/or the one or more components of the asset were associated with a normal operating state (e.g., when the asset and/or the one or more components of the asset were not associated with a fault). In some embodiments, using the historical normal dataset, the asset optimization system may train the fault detection model using a principal component analysis technique. Additionally or alternatively, using the historical normal dataset, the asset optimization system may train the fault detection model using an encoder and/or decoder technique.

In some embodiments, the asset optimization system may be configured to generate a fault anomaly score graphical representation at least in part on the operational data and/or the fault anomaly score. In this regard, for example, the fault anomaly score graphical representation may include a fault score representation. Additionally or alternatively, the fault anomaly score graphical representation may include a fault anomaly score threshold representation.

In some embodiments, the asset optimization system may be configured to perform data augmentation and/or data annotation on the operational data at least in part by applying the operational data to a fault annotation model. In some embodiments, the fault annotation model may comprise one or more of a statistical model, an algorithmic model, a control systems model, a first principles model, a reinforcement learning model, and/or a machine learning model (e.g., using AI, machine learning, and reinforcement learning circuitry). In this regard, the fault annotation model may be configured to perform data augmentation and/or data annotation on the operational data by performing one or more of a jittering technique, a scaling technique, a magnitude warping technique, a time warping technique, a rotation technique, a permutation technique, a random sampling technique, a rotation and permutation technique, and/or the like.

As shown in block 608, the method may include in accordance with a determination that the operational data is indicative of the asset being associated with the at least one fault generating, based at least in part on applying the operational data to a fault classification model, fault data. As described above, in some embodiments, in accordance with a determination that the operational data is indicative of the asset being associated with at least one fault (e.g., when the fault anomaly score is above the fault anomaly score threshold), the asset optimization system may be configured to generate fault data. In some embodiments, the asset optimization system may be configured to generate the fault data at least in part by applying the operational data to a fault classification model (e.g., after data augmentation and/or data annotation has been performed on the operational data by the fault annotation model). In some embodiments, the fault classification model may comprise one or more of a statistical model, an algorithmic model, a control systems model, a first principles model, a reinforcement learning model, and/or a machine learning model (e.g., using AI, machine learning, and reinforcement learning circuitry). In this regard, for example, the fault classification model may be configured to generate the fault data using one or more of a random forest technique and/or a long short-term memory (LSTM) technique.

In some embodiments, the fault data may be representative of a particular type of fault associated with the at least one fault associated with the asset and/or components of the asset from a plurality of fault types. In this regard, for example, the asset may be configured such that it may be associated with one or more of a plurality of fault types. For example, the asset may be associated with an air handling unit fault type (e.g., an air handling component fault type that include a fault associated with the coil of an air handling unit). As another example, the asset may be associated with a HVAC fault type. As another example, a sensor component of the asset may be associated with a sensor fault type. In this regard, based at least in part on the operational data, the fault classification model may be configured to classify the at least one fault into an appropriate fault type out of a plurality of fault types that the asset could be associated with. Said differently, by applying the operational data to the fault classification model, the asset optimization system may be configured to identify the particular fault type associated with the at least one fault associated with the asset.

In some embodiments, if the fault data indicates that a sensor type component of the asset is associated with a sensor fault type, the fault data may be configured to indicate if the fault associated with a sensor component of the asset is a transient fault, an intermittent fault, and/or a permanent fault. In some embodiments, a transient fault may be a fault associated with a short duration and/or only appears once (e.g., only appears during the short duration). In some embodiments, an intermittent fault may be a fault associated with a sensor component that oscillates between a normal state and a fault state (e.g., an intermittent fault includes a sensor component that is associated with a fault state more than once). In some embodiments, a permanent fault may be a fault in which a sensor component remains in a fault state until action is taken to remedy the fault.

In some embodiments, the asset optimization system may be configured to generate a sensor fault type graphical representation at least in part on the fault data (e.g., when the fault data indicates that there is a fault associated with a sensor component). In this regard, for example, the sensor fault type graphical representation may include a transient fault representation. Additionally or alternatively, the sensor fault type graphical representation may include an intermittent fault representation. Additionally or alternatively, the sensor fault type graphical representation may include a permanent fault representation.

As shown in block 610, the method may include in accordance with a determination that the operational data is indicative of the asset being associated with the at least one fault generating, based at least in part on applying the fault data to a fault impact model, fault impact data. As described above, in some embodiments, in accordance with a determination that the operational data is indicative of the asset being associated with at least one fault (e.g., when the fault anomaly score is above the fault anomaly score threshold), the asset optimization system may be configured to generate fault impact data. In some embodiments, the asset optimization system may be configured to generate the fault impact data at least in part by applying the fault data to a fault impact model. In some embodiments, the fault impact model may comprise one or more of a statistical model, an algorithmic model, a control systems model, a first principles model, a reinforcement learning model, and/or a machine learning model (e.g., using AI, machine learning, and reinforcement learning circuitry). For example, the fault impact model may comprise a reinforcement learning model.

In some embodiments, the fault impact data may be representative of the impact of the at least one fault on the asset and/or the components of the asset. For example, the fault impact data may indicate the efficiency of the asset and/or the components of the asset compared to an efficiency of the asset and/or the components of the asset when not associated with the at least one fault (e.g., ninety percent efficiency versus forty percent efficiency). As another example, the fault impact data may indicate a cost associated with operating the asset and/or the components of the asset when the asset is associated with the at least one fault and/or the components of the asset are associated with the at least one fault (e.g., cost due to damage to the asset and/or the components of the asset due to operating when associated with the at least one fault, cost due to lost production capacity of the asset and/or the components of the asset compared to operating without the at least one fault, etc.). As another example, the fault impact data may indicate a cost associated with performing one or more maintenance actions of the asset and/or the components of the asset (e.g., cost of parts to fix the at least one fault, production capacity lost due to having to take the asset and/or components of the asset offline to perform maintenance, etc.). As another example, the fault impact data may indicate an emissions amount associated with the asset and/or the components of the asset compared to an emissions associated with the asset and/or components of the asset when not associated with the at least one fault (e.g., the asset and/or components of the asset may generate greater emissions when associated with the at least one fault).

As shown in block 612, the method may include in accordance with a determination that the operational data is indicative of the asset being associated with the at least one fault initiating performance of one or more fault optimization actions based at least in part on the fault impact data. As described above, in some embodiments, the asset optimization system may be configured to initiate performance of one or more fault optimization actions based at least in part on the fault impact data (e.g., cause one or more fault optimization actions to occur). For example, the asset optimization system may be configured to initiate performance of one or more fault optimization actions based at least in part on the fault impact data using at least the controller. In some embodiments, the one or more fault optimization actions may include at least one short-term fault optimization action. In some embodiments, the short-term fault optimization action may be associated with a short-term time period. In some embodiments, the short-term time period may be a time period associated with the current operations and/or near-term operations of the asset. For example, the short-term time period may refer to the operations of the asset on the current hour, day, week, month, year, and/or the like and/or next hour, day, week, month, year, and/or the like.

In some embodiments, the one or more fault optimization actions may include at least one long-term fault optimization actions. In some embodiments, the long-term fault optimization action may be associated with a long-term time period. For example, the long-term time period may refer to the operations of the asset on a future hour, day, week, month, year, etc. In some embodiments, the long-term time period may be a time period associated with the future (e.g., planned) operations of the asset in the long-term time period (e.g., a time period other than the short-term time period) while the short-term time period may be a time period associated with the current operations and/or near-term operations of the asset (e.g., a time period other than the long-term time period).

In some embodiments, for example, the asset optimization system may be configured to initiate a short-term fault optimization action that includes initiating performance of one or more maintenance actions in the short-term time period. For example, the short-term fault optimization action may include one or more maintenance actions to remedy a fault associated with an air handling component in the short-term time period. As another example, the asset optimization system may be configured to initiate a short-term fault optimization action that includes initiating performance of one or more continue operating actions in the short-term time period. For example, the short-term fault optimization action may include one or more continue operating actions in which the asset and/or components of the asset (e.g., a HVAC component) continue to operate as is in the short-term time period and the asset and/or affected by the at least one fault is not remedied within the short-term time period.

In some embodiments, for example, the asset optimization system may be configured to initiate a long-term fault optimization action that includes initiating performance of one or more maintenance actions in the long-term time period. For example, the long-term fault optimization action may include one or more maintenance actions to remedy a fault associated with an air handling component in the long-term time period (e.g., the fault is not remedied in the short-term time period). As another example, the asset optimization system may be configured to initiate a long-term fault optimization action that includes initiating performance of one or more continue operating actions in the long-term time period. For example, the long-term fault optimization action may include one or more continue operating actions in which the asset and/or components of the asset (e.g., a HVAC component) continue to operate as is in the long-term time period and the asset and/or affected by the at least one fault is not remedied within the long-term time period (e.g., the at least one fault may be remedied in the short-term time period or not be remedied in the short-term time period or the long-term time period).

As shown in block 614, the method may optionally include performing a first training of the fault impact model. As described above, in some embodiments, the asset optimization system may be configured to perform a first training of the fault impact model. In this regard, the asset optimization system may be configured to train the fault impact model by identifying a historical dataset. In some embodiments, the historical dataset may include historical fault data. In some embodiments, the historical fault data may be representative of a particular type of fault associated with the at least one historical fault associated with the asset, another asset, one or more components of the asset, and/or one or more components of another asset from a plurality of fault types. Additionally or alternatively, the historical dataset may include historical fault impact data. In some embodiments, the historical fault impact data may be representative of the impact at least one fault had on the asset, another asset, one or more components of the asset, and/or one or more components of another asset from a plurality of fault types.

In some embodiments, the historical dataset may include labeled data. For example, the historical fault data and/or the historical fault impact data may be labeled data. In this regard, the historical fault data and/or the historical fault impact data may have been augmented with one or more labels comprising data about the historical fault data and/or the historical fault impact data. For example, the labels may comprise data indicating date of capture associated with the historical fault data and/or the historical fault impact data, location of capture associated with the historical fault data and/or the historical fault impact data, fault type associated with the historical fault data and/or the historical fault impact data, impact associated with the historical fault data and/or the historical fault impact data, and/or the like.

In some embodiments, the asset optimization system may be configured to train the fault impact model using one or more machine learning techniques. For example, the asset optimization system may be configured to train the fault impact model using a supervised machine learning technique and/or an unsupervised machine learning technique. In some embodiments, the asset optimization system may be configured to train the fault impact model based at least in part on the historical dataset. For example, the asset optimization system may be configured to train the fault impact model based at least in part on the historical fault data and/or the historical fault impact data.

As shown in block 616, the method may optionally include performing a second training of the fault impact model. As described above, in some embodiments, the asset optimization system may be configured to perform a second training of the fault impact model. In some embodiments, the asset optimization system may be configured to train the fault impact model based at least in part on the fault data and/or the fault impact data. In this regard, for example, the asset optimization system may be configured to train the fault impact model using one or more reinforced learning techniques using the fault data and/or the fault impact data.

In some embodiments, the fault data and/or the fault impact data may be unlabeled data (e.g., the fault data and/or the fault impact data have not been augmented with labels). In this regard, the asset optimization system may be able to continually optimize the fault impact model through the training using one or more reinforced learning techniques (e.g., the second training) without reliance on labeled data, such as the historical fault data and/or the historical fault impact data in the historical dataset.

Operations and/or functions of the present disclosure have been described herein, such as in flowcharts. As will be appreciated, computer program instructions may be loaded onto a computer or other programmable apparatus (e.g., hardware) to produce a machine, such that the resulting computer or other programmable apparatus implements the operations and/or functions described in the flowchart blocks herein. These computer program instructions may also be stored in a computer-readable memory that may direct a computer, processor, or other programmable apparatus to operate and/or function in a particular manner, such that the instructions stored in the computer-readable memory produce an article of manufacture, the execution of which implements the operations and/or functions described in the flowchart blocks. The computer program instructions may also be loaded onto a computer, processor, or other programmable apparatus to cause a series of operations to be performed on the computer, processor, or other programmable apparatus to produce a computer-implemented process such that the instructions executed on the computer, processor, or other programmable apparatus provide operations for implementing the functions and/or operations specified in the flowchart blocks. The flowchart blocks support combinations of means for performing the specified operations and/or functions and combinations of operations and/or functions for performing the specified operations and/or functions. It will be understood that one or more blocks of the flowcharts, and combinations of blocks in the flowcharts, can be implemented by special purpose hardware-based computer systems which perform the specified operations and/or functions, or combinations of special purpose hardware with computer instructions.

While this specification contains many specific embodiments and implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

While operations and/or functions are illustrated in the drawings in a particular order, this should not be understood as requiring that such operations and/or functions be performed in the particular order shown or in sequential order, or that all illustrated operations be performed, to achieve desirable results. In certain circumstances, operations and/or functions in alternative ordering may be advantageous. In some cases, the actions recited in the claims may be performed in a different order and still achieve desirable results. Thus, while particular embodiments of the subject matter have been described, other embodiments are within the scope of the following claims.

While this specification contains many specific embodiment and implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are illustrated in the drawings in a particular order, this should not be understood as requiring that such operations be performed in the particular order shown or in sequential order, or that all illustrated operations be performed, to achieve desirable results. In certain circumstances, operations in alternative ordering may be advantageous. In some cases, the actions recited in the claims may be performed in a different order and still achieve desirable results.

That which is claimed:

1. A computer-implemented method comprising:
receiving operational data representing operations of an asset;
processing the operational data to generate a fault anomaly score for the operational data;
determining, based at least in part on the fault anomaly score, whether the operational data is indicative of the asset being associated with at least one fault;
in accordance with a determination that the operational data is indicative of the asset being associated with the at least one fault:
generating, based at least in part on applying the operational data to a fault classification model, fault data;
generating, based at least in part on applying the fault data to a fault impact model, fault impact data, wherein the fault impact model comprises a reinforcement learning model; and
initiating performance of one or more fault optimization actions based at least in part on the fault impact data.

2. The computer-implemented method of claim 1, wherein the one or more fault optimization actions include at least one short-term fault optimization action.

3. The computer-implemented method of claim 1, wherein the one or more fault optimization actions include at least one long-term fault optimization action.

4. The computer-implemented method of claim 1, further comprising:
performing a first training of the fault impact model, wherein the first training of the fault impact model comprises:
identifying a historical dataset, wherein the historical dataset comprises labeled data; and
training the fault impact model using a machine learning technique based at least in part on the historical dataset.

5. The computer-implemented method of claim 4, wherein the machine learning technique is a supervised machine learning technique.

6. The computer-implemented method of claim 4, further comprising:
performing a second training of the fault impact model, wherein the second training of the fault impact model comprises:
training the fault impact model based at least in part on the fault data.

7. The computer-implemented method of claim 6, wherein the fault data is unlabeled data.

8. The computer-implemented method of claim 1, wherein the fault data indicates a fault type associated with the at least one fault.

9. The computer-implemented method of claim 1, wherein the fault anomaly score is generated at least in part by performing a principal component analysis technique.

10. The computer-implemented method of claim 1, wherein the at least one fault is at least one of a transient fault, an intermittent fault, or a permanent fault.

11. An apparatus comprising at least one processor and at least one non-transitory memory including computer-coded instructions thereon, the computer coded instructions, with the at least one processor, cause the apparatus to:
receive operational data representing operations of an asset;
process the operational data to generate a fault anomaly score for the operational data;
determine, based at least in part on the fault anomaly score, whether the operational data is indicative of the asset being associated with at least one fault;
in accordance with a determination that the operational data is indicative of the asset being associated with the at least one fault:
generate, based at least in part on applying the operational data to a fault classification model, fault data;
generate, based at least in part on applying the fault data to a fault impact model, fault impact data, wherein the fault impact model comprises a reinforcement learning model; and
initiate performance of one or more fault optimization actions based at least in part on the fault impact data.

12. The apparatus of claim 11, wherein the one or more fault optimization actions include at least one short-term fault optimization action.

13. The apparatus of claim 11, wherein the one or more fault optimization actions include at least one long-term fault optimization action.

14. The apparatus of claim 11, wherein the computer coded instructions, further with the at least one processor, cause the apparatus to:
perform a first training of the fault impact model, wherein the first training of the fault impact model comprises:
identifying a historical dataset, wherein the historical dataset comprises labeled data; and
training the fault impact model using a machine learning technique based at least in part on the historical dataset.

15. The apparatus of claim 14, wherein the computer coded instructions, further with the at least one processor, cause the apparatus to:
perform a second training of the fault impact model, wherein the second training of the fault impact model comprises:
training the fault impact model based at least in part on the fault data.

16. The apparatus of claim 15, wherein the fault data is unlabeled data.

17. The apparatus of claim 11, wherein the fault data indicates a fault type associated with the at least one fault.

18. The apparatus of claim 11, wherein the fault anomaly score is generated at least in part by performing a principal component analysis technique.

19. The apparatus of claim 11, wherein the at least one fault is at least one of a transient fault, an intermittent fault, or a permanent fault.

20. A computer program product comprising at least one non-transitory computer-readable storage medium having computer program code stored thereon that, in execution with at least one processor, configures the computer program product for:
receiving operational data representing operations of an asset;
processing the operational data to generate a fault anomaly score for the operational data;
determining, based at least in part on the fault anomaly score, whether the operational data is indicative of the asset being associated with at least one fault;
in accordance with a determination that the operational data is indicative of the asset being associated with the at least one fault:
generating, based at least in part on applying the operational data to a fault classification model, fault data;
generating, based at least in part on applying the fault data to a fault impact model, fault impact data, wherein the fault impact model comprises a reinforcement learning model; and
initiating performance of one or more fault optimization actions based at least in part on the fault impact data.
